(19) United States
(12) Patent Application Publication
(10) Pub. No.: US 2008/0291973 A1
(43) Pub. Date: Nov. 27, 2008

(54) Integrated Ultra-Wideband (Uwb) Pulse Generator

(75) Inventors: Abdellatif Azakkour, Cambridge (GB); Myriam Regis, Cergy Le Haut (FR)

Correspondence Address: YOUNG & THOMPSON, 209 Madison Street, Suite 500, ALEXANDRIA, VA, 22314, US

(73) Assignee: ACCO, Saint-Germain-En-Laye (FR)

(21) Appl. No.: 11/667,831

(22) PCT Filed: Nov. 16, 2005
(86) PCT No.: PCT/IB05/03426

§ 371 Date: Dec. 27, 2007

Related U.S. Application Data
(60) Provisional application No. 60/628,449, filed on Nov. 16, 2004.

(51) Int. Cl. H04B 1/69

(52) U.S. Cl. 375/130

(57) ABSTRACT

A pulse generator includes a sinusoidal monocycle generator (4). The sinusoidal monocycle generator (4) includes a sinusoidal wave source (5) connected to a first switch (6) and to a first input of a first multiplier (7), the output of the switch being a square pulse synchronized with a sinusoidal wave generated by the sinusoidal wave source and has a pulse width equal to one period of the sinusoidal wave in the time domain. The switch (6) output is connected to a second input of the first multiplier (7) so that the output of the multiplier is a sinusoidal monocycle.

### FIELD OF THE INVENTION

This invention relates to a new pulse generator for UWB applications.

### BACKGROUND OF THE INVENTION

Since February 2002, the Federal Communication Commission (FCC) has conditionally allocated 7.5 GHz of spectrum for unlicensed types of ultra-wideband (UWB) wireless systems in the 3.1 to 10.6 GHz frequency band. The UWB technologies are developed to be used for super-high-speed communication, geolocation and highly-accurate sensing, low cost RF tagging, and so forth. UWB differs from other RF technologies. Instead of using a narrowband frequency carrier to transmit data, UWB technologies send impulses of energy across a spectrum of frequencies. Today, most radio technologies use the modulation of a carrier, but at the beginning of the last century, physics and radio engineers used a spark gap to generate ultra wideband signals for transmission of data before sinusoidal carriers were invented. However, the generation of impulses and their adequate control for effective communication purposes were extremely difficult to master until recently. In the recent past, creative methods have been proposed to implement the impulse waveform generator.

There are two dominant technologies for UWB. One is based on the multiband technique that uses modulated signals to fall into the desired bandwidth, and the other, which is the technology considered here, is the Impulse Radio (UWB-IR) technique that uses sub-nanosecond pulses to transmit data. Gaussian pulses offer an excellent time-frequency resolution product. Several papers have been published to suggest new methods to generate UWB-IR pulses, such as the Gaussian monocycle. These pulse types have the common characteristic of having a very wideband spectrum.

L. B. Michael, M. Ghavami, R. Kohno “Multiple pulse generator for ultra-wideband communication using Hermite polynomial based orthogonal pulses”, Digest of 2002 UWBST IEEE Conference, 21-23 May 2002, pp. 47-51, and J. Han et al, “A new ultra-wideband, ultra_short monocycle pulse generator with reduced ringing”, IEEE Microwave and Wireless Components Letters, vol. 12, n^{o} 6, June 2002, pp. 206-208, disclose such techniques to generate UWB-IR pulses.

However, the disclosed apparatus are complex and difficult to implement on an integrated circuit.

### SUMMARY OF THE INVENTION

A goal of the invention is to provide a simple pulse generator, easy to integrate.

It is therefore an object of this invention to provide a short pulse generator for UWB transmission. The target is to integrate the complete pulse generator with several modulation types.

The pulse generator comprises a sinusoidal monocycle generator. The sinusoidal monocycle generator comprises a sinusoidal wave source connected to a first switch and to a first input of a first multiplier, the output of the switch being a square pulse synchronized with a sinusoidal wave generated by the sinusoidal wave source and having a pulse width equal to one period of said sinusoidal wave in the time domain. The switch output is connected to a second input of the first multiplier so that the output of the multiplier is a sinusoidal monocycle.

In a preferred embodiment, the switch is a synchronous counter having a clock input and control inputs, the sinusoidal wave being the clock of the counter and the control inputs defining the number of periods of the clock separating each square pulse outputted from said counter.

In a UWB transmission, a pseudo-noise sequence code is used to spread signals.

In a preferred embodiment, the pulse generator comprises a pseudo-noise sequence prescaler, the pseudo-noise sequence prescaler being synchronized with the output of the switch. The pseudo-noise sequence prescaler comprises a counter synchronized with the output of the switch, the counter driving at least a multiplexer to serialize a subset of a pseudo-noise sequence code.

An advantage of the pseudo-noise sequence prescaler is to synchronise the output of the pseudo-noise sequence code with the sinusoidal monocycle.

Therefore, in this invention the circuit is able to generate a short pulse with different modulation schemes. In the case of the bi-phase modulation, two multipliers are used to modulate the code and the data. For the pulse position modulation (PPM) two delay blocks, two switches and a multiplier are used to modulate the code and the data. Of course it is possible to implement a combination of these two modulations.

Specific embodiments of the invention for different modulation schemes are described in claims 5 and following.

An advantage of the pulse generator according to the invention is its easiness to control the impulse frequency centre. The apparatus is synchronized by the sinusoidal wave source and the pulse width is directly dependent on the source frequency.

In a specific embodiment of the invention, the generator comprises a counter. Advantageously, the pulse repetition frequency is easily changed by modifying the counter division ratio.

### BRIEF DESCRIPTION OF THE DRAWINGS

The invention will now be described, by way of examples, with reference to the drawings in which:

FIG. 1 is a diagram of comparison between a sinusoidal and a derivative Gaussian monocycle in the time domain,

FIG. 2 is a diagram of comparison between the sinusoidal and derivative Gaussian monocycles of FIG. 1 in the frequency domain,

FIG. 3 is a schematic of an embodiment of a sinusoidal monocycle generator,

FIG. 4 is a time diagram of the waves generated into the sinusoidal monocycle generator of FIG. 3,

FIG. 5 is a schematic of another embodiment of the sinusoidal monocycle generator of FIG. 3,

FIG. 6 is a schematic of an embodiment of a pseudo-noise sequence prescaler,

FIG. 7 is a schematic of a pulse generator comprising the sinusoidal monocycle generator of FIG. 3 and the pseudo-noise sequence prescaler of FIG. 6,

FIG. 8 is a schematic of the pulse generator configuration with BPSK-BPSK modulation scheme for both code and data,

FIG. 9 is a chronogram corresponding to the BPSK-BPSK modulation scheme of FIG. 8,

FIG. 10 is a block diagram of the pulse generator with PPM-PPM modulation for both code and data,

FIG. 11 is a chronogram corresponding to the PPM-PPM modulation scheme,

FIG. 12 is a block diagram of the pulse generator with BPSK-PPM modulation (BPSK for the code and PPM for the data),

FIG. 13 is a the chronogram corresponding to the BPSK-PPM modulation scheme,

FIG. 14 is a block diagram of the pulse generator with PPM-BPSK modulation (PPM for the code and BPSK for the data), and

FIG. 15 is a chronogram corresponding to the PPM-BPSK modulation scheme.

### DESCRIPTION OF THE PREFERRED EMBODIMENTS

As illustrated by FIG. 1, a theoretical impulse 1 is similar to one cycle of a sinusoidal wave 2 in the time domain where the theoretical impulse 1 is defined as a derivative Gaussian monocycle.

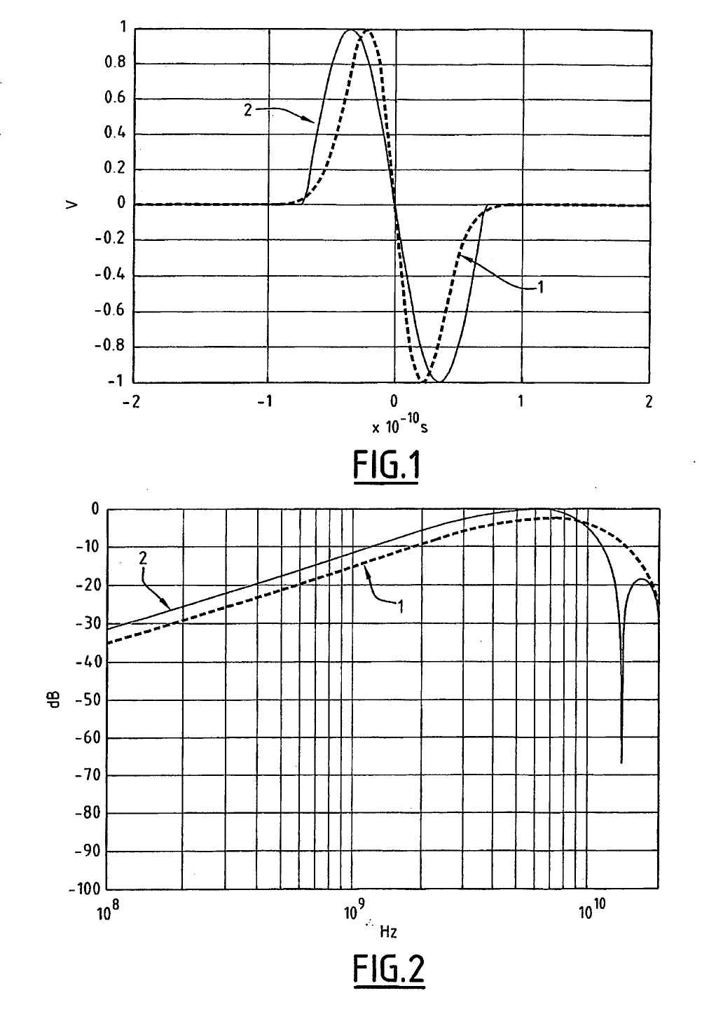

In the frequency domain, FIG. 2, the theoretical impulse 1 and the one cycle of the sinusoidal wave 2, hereafter called the sinusoidal monocycle, correspond to ultra-wideband signals.

Therefore, in the preferred embodiment of a pulse generator, the generated signal is based on a short sinusoidal monocycle which is equivalent, in the frequency domain, to a wide-band spectrum signal.

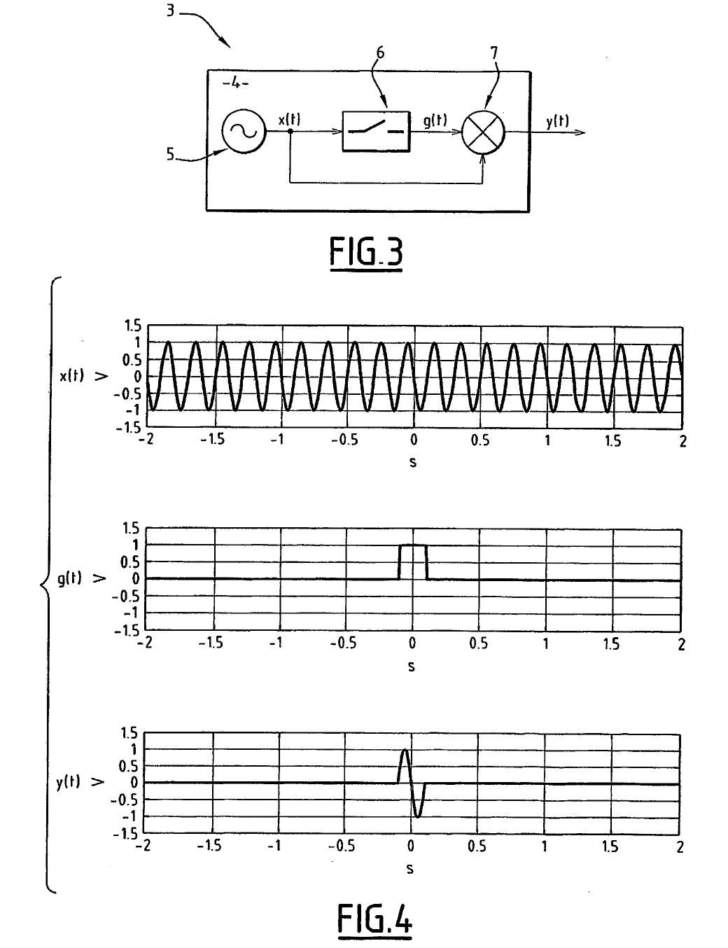

A pulse generator 3, FIG. 3, comprises a sinusoidal monocycle generator 4.

The sinusoidal monocycle generator 4 comprises a sinusoidal wave source 5. A well-known example of an embodiment of a sinusoidal wave source is a Voltage-Controlled Oscillator (VCO).

The output x(t) of the sinusoidal wave source 5 is connected to an on-off switch 6. The on-off switch 6 generates a square pulse g(t) synchronized with the sinusoidal wave x(t) and having a pulse width equal to one period of the sinusoidal wave in the time domain.

A multiplier 7 receives the square pulse g(t) generated by the on-off switch 6 and the sinusoidal wave signal x(t) generated by the sinusoidal wave source 5, and multiplies them so that a sinusoidal monocycle y(t) is generated by the multiplier 7.

The behaviour of the pulse generator is explained now in reference to FIG. 4 which illustrates the different waveforms.

The signal y(t) at the output of the multiplier 7 is given by

y(t)=x(t)g(t)

When the switch 6 is closed, g(t)=1, and when the switch 6 is open, g(t)=0.

As shown by FIG. 4, the synchronization and the control of the width of the square pulse g(t) in relation with the sinusoidal wave signal x(t) are major to the quality of the obtained sinusoidal monocycle y(t).

In a preferred embodiment of the sinusoidal monocycle generator, the switch 6 is a counter. The sinusoidal wave signal x(t) is used as the clock of the counter which has control inputs 8 to parameterize it. The control inputs 8 are used to control the pulse repetition frequency. For instance, through the control inputs 8, a value N is predetermined. At each period of the clock, the counter is incremented by 1 until it reaches the value N. Then a “hit” signal is generated which is the square pulse signal g(t) used as input of the multiplier 7 and the counter 6 is reset to start a new counting cycle. The skilled person may use other type of counters to reach the same goal which is to generate regularly a square pulse synchronized with the sinusoidal wave.

Before transmitting the information, the technique of spread spectrum modulation is used. Not only does this technique have the advantage of smoothing the power spectral density of the signal but it can also give the signal a noise-like appearance for the other (unauthorized) receivers. Thus multiple user transmissions can simultaneously occupy the same frequency band with guaranteed message privacy, provided that each user's signal has been spread using a unique pseudo-random code, also referred to as pseudo-noise (PN) sequence code. The PN sequence code must be synchronized with the transmitted impulses to avoid errors such as to have a code transition during a monocycle.

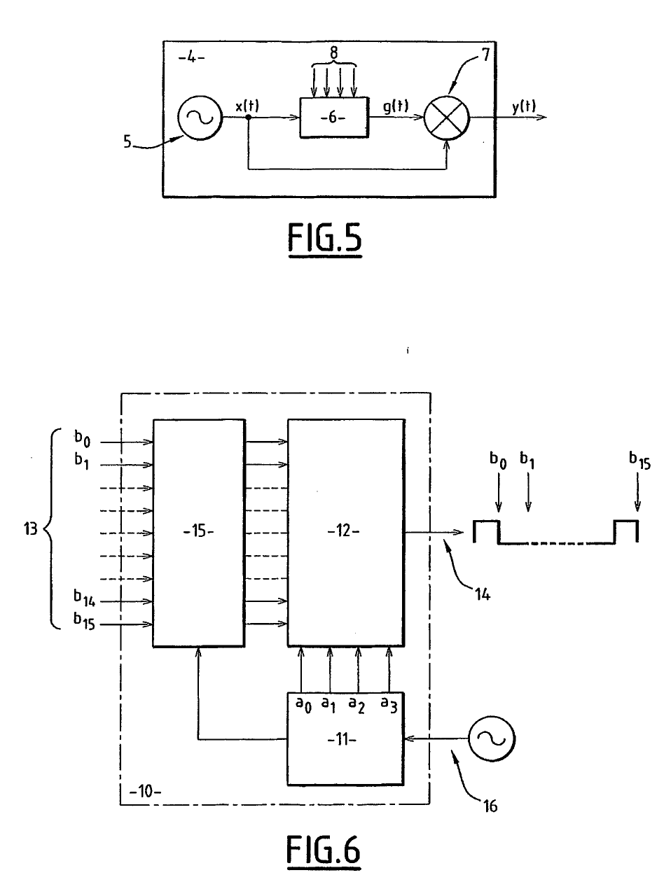

The pulse generator 3 further comprises a pseudo-noise sequence prescaler 10, as illustrated in FIG. 6, comprising a counter 11. In a preferred embodiment, the counter 11 is a counter by 16. The counter 11 is driving at least one multiplexer 12. Each multiplexer 12 receives as input a unique pseudo-random code 13 and outputs in 14, serially, the unique pseudo-code 13 in synchronization with the counter 11. The multiplexer receives the pseudo-random code 13 from a memory 15.

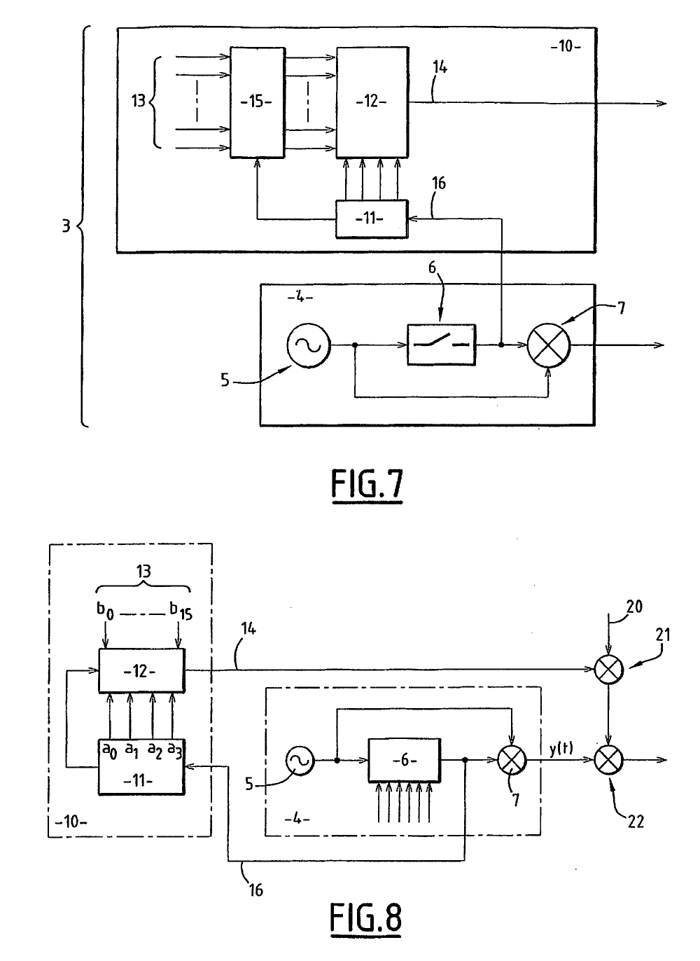

The pseudo-noise sequence prescaler 10 is synchronized with the sinusoidal monocycle generator 4 by connecting the clock signal input 16 of the pseudo-noise sequence prescaler 10 to the output of the on-off switch 6 so that the square pulse is used as the clock of the pseudo-noise sequence prescaler 10, as in FIG. 7.

Any untimely changes of the 16 bits code are isolated by the memory 15. For each rise time of the counter, the multiplexer 12 selects one code value from b0 to b15, and then a “load” signal is emitted by the counter 11 to load the next 16 code values in the memory 15. This bufferization may be achieved by other means well known of the skilled person with the goal to avoid any disruption in the serialized flow of the PN sequence code outputted by the multiplexer 12.

Depending on the type of modulation used, the serial pseudo-code and data to be transmitted are multiplexed and modulate the sinusoidal monocycle as explained hereafter.

In UWB transmission, the information can be encoded by using different methods. The embodiment of the pulse generator described here is particularly suitable to be used with two types of modulation: bi-phase shift keying modulation (BPSK) and pulse position modulation (PPM) independently for code or data.

Four configurations will be explained hereafter: BPSK-BPSK, PPM-PPM, PPM-BPSK, BPSK-PPM to transmit respectively the pseudo-noise (PN) sequence code and the data.

FIG. 8 shows the pulse generator configuration with a BPSK-BPSK modulation scheme for both code and data. The PN sequence prescaler 10 controls the BPSK modulation. In this configuration, the information is encoded with the phase (0 or 180°) of the impulses, i.e. the phase of the impulses is switched to encode a 0 or a 1. To achieve this function, the serialized PN sequence code (14) and data 20 to transmit are multiplied together in a second multiplier 21. The result is multiplied again by the impulses y(t) outputted by the sinusoidal pulse generator 4 in a third multiplier 22. The output of the system is a modulated bi-phase impulses signal.

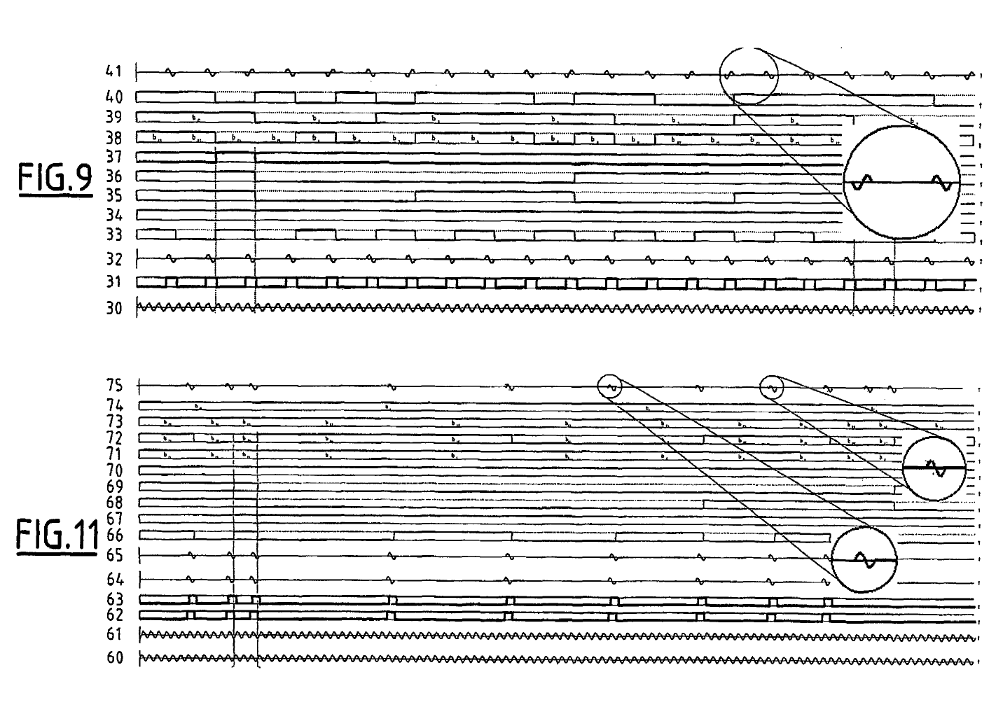

FIG. 9 is the chronogram corresponding to the BPSK-BPSK modulation scheme where:
the curve 30 is the clock signal,
the curve 31 is the output signal of the counter 6 for a division ratio of 4,
the curve 32 is the output of the multiplier 7, the product result of curves 30 and 31,
the curves 33, 34, 35 and 36 are the output bits of the counter 11. a0 divides by 2, a1 divides by 4, a2 divides by 8, a3 divides by 16. These division ratios control the multiplexer 12 to load the PN sequence code,
the curve 37 is the loading signal used to enable the multiplexer for the next loading of the PN sequence code into the memory 15,
the curve 38 is the output signal of the multiplexer 12, i.e. the serialized PN sequence code,
the curve 39 is the transmitted data,
the curve 40 is the product result of the data (curve 39) and the code (curve 38) at the output of the second multiplier 21, and
the curve 41 is the resulting BPSK modulation (see zoom area) where there is 180° phase shift between the code 0 and 1.

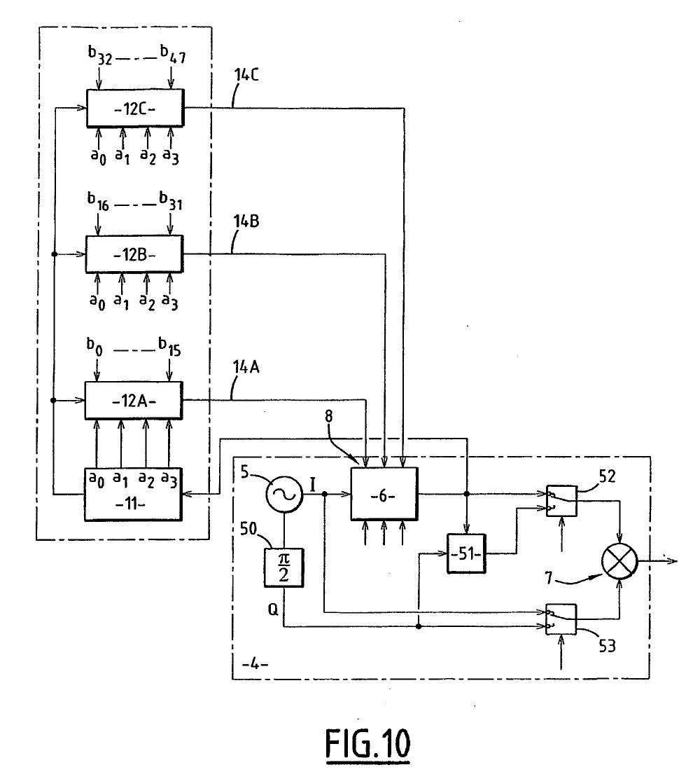

FIG. 10 is a block diagram of a pulse generator with PPM-PPM modulation for both code and data.

PPM modulation is based on the principle of encoding information with two positions in time, referred to the nominal pulse position. A pulse transmitted at the nominal position represents a 0, and a pulse transmitted after the nominal position represents a 1. In the described embodiment, one bit is encoded in one impulse, but, in general, additional positions can be used to provide more bits per symbol. The time delay between positions is typically a fraction of a nanosecond, while the time between nominal positions is typically much longer to avoid any interference between impulses. The principle used in this modulation is to change, in real time, the division ratio dependent on each PN sequence code values. This ratio will define the time between impulses, and thus, their position in the frame.

The data modulation is achieved by fixing a delay of same length on the clock and the counter output.

The sinusoidal monocycle generator 4 comprises a delay 50 to generate a quadratic phase signal, or Q signal, of the sinusoidal wave signal, or I signal. A delay block 51 has an input connected to the output of the switch/counter 6 and a control delay input connected to the quadratic phase signal Q so that the output of the switch 51 is a square pulse having the same characteristics as the square pulse generated by the counter 6 but synchronized on the quadratic phase signal.

A two-position switch 52 has its two data inputs connected to the window pulse generated by the counter 6 and the window pulse generated by the switch 51 respectively. The two-position switch 52 has a control input connected to serialized data to transmit.

In parallel, a second two-position switch 53 has two data inputs connected to the sinusoidal waveform signal and the quadratic phase signal respectively. The two-position switch 53 has a control input connected to the same serialized data to transmit as the switch 52.

Therefore depending of the value of the data, i.e. 0 or 1, either the window pulse generated directly by the counter 6 and the sinusoidal waveform signal are inputted to the multiplier 7, either the corresponding quadratic signals are used to generate the sinusoidal monocycle.

The PN sequence prescaler 10 comprises three multiplexers 12A, 12B, 12C driven in parallel by the counter 11. The three outputs 14A, 14B, 14C of the multiplexers 12A, 12B, and 12C are serialized portions of the PN sequence code and are used to control three bit lines of the control input 8 of the counter 6. Therefore the pulse repetition frequency is determined by the values of the serialized portions 14A, 14B, 14C of the PN sequence code, thus defining the position of the impulses in the frame.

FIG. 11 is a chronogram corresponding to the PPM-PPM modulation scheme where:
the curves 60 and 61 are the I and Q clock signals with 90° phase shift,
the curves 62 and 63 are the I and Q gate signals respectively provided by the counter 6 and the switch 51,
the curves 64 and 65 are, respectively, the product result of curves 60, 62 and curves 61, 63. These monocycles I and Q are modulated with the PN sequence code,
the curves 66, 67, 68 and 69 are the output bits of the counter by 16. a0 divides by 2, a1 divides by 4, a2 divides by 8, a3 divides by 16. These division ratios control the three multiplexers to load the PN sequence code,
the curve 70 is the loading signal used to enable the multiplexers for the next loading,
the curves 71, 72 and 73 are the output signals of the multiplexers (serialized PN sequence code),
the curve 74 is the transmitted data, and
the curve 75 is the desired modulation (see zoom area). Indeed, the relative position of the pulse has changed between the code 0 and 1.

In this described embodiment, one bit is encoded in one impulse. This embodiment can be generalized for modulation scheme where more bits are coded by impulse.

Multiple delay blocks generate sinusoidal waveform signals from the original sinusoidal waveform signal with different phase shifting, so that there are 2N waveforms signals.

Delay blocks controlled by the different phase-shifted waveform signals and having as input the window pulse of the switch 6 generate window pulses with the same phase shifting.

The two-position switches 52, 53 are replaced by two 2^{N} positions switches. The two switches 52, 53 are controlled by the data to be transmitted, data being inputted to the switches N at the time.

For instance, for a symbol of 2 bits to be transmitted, sinusoidal waveform signals with

$$0 , \frac{π}{2} , π , \frac{3 π}{2}$$

phases are generated. The switches 52, 53 are 4 positions switches with two control bit lines.

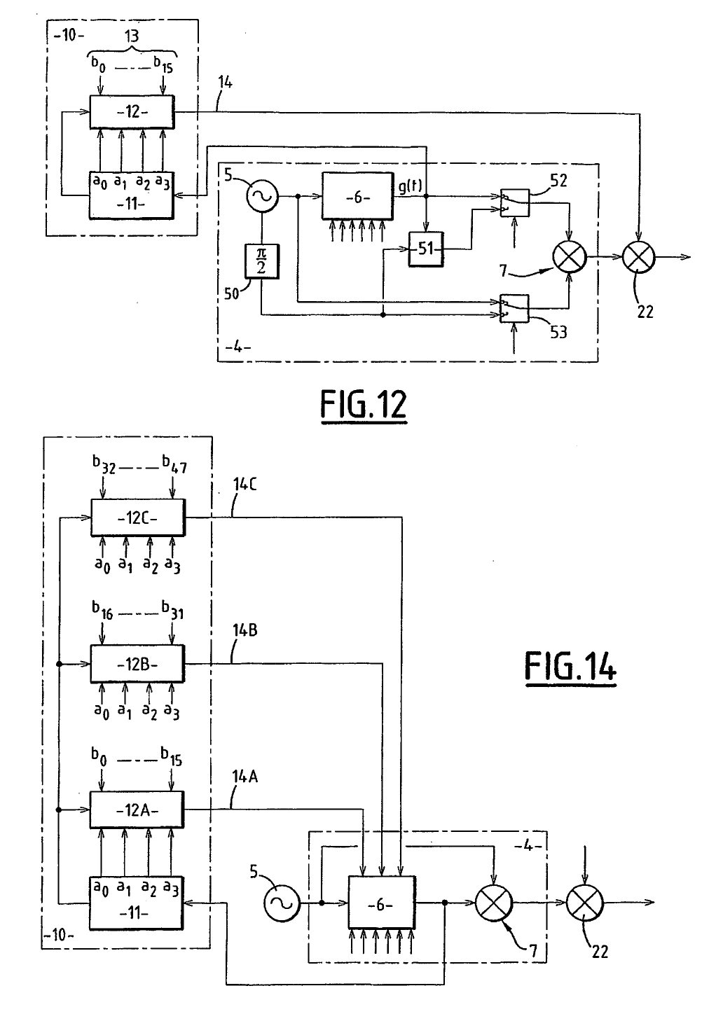

FIG. 12 is a block diagram of the pulse generator with BPSK-PPM modulation (BPSK for the code and PPM for the data). This configuration is an association between the previous configurations BPSK-BPSK and PPM-PPM. As previously, to synchronize all the system the PN sequence prescaler clock is connected to the output waveform generator counter.

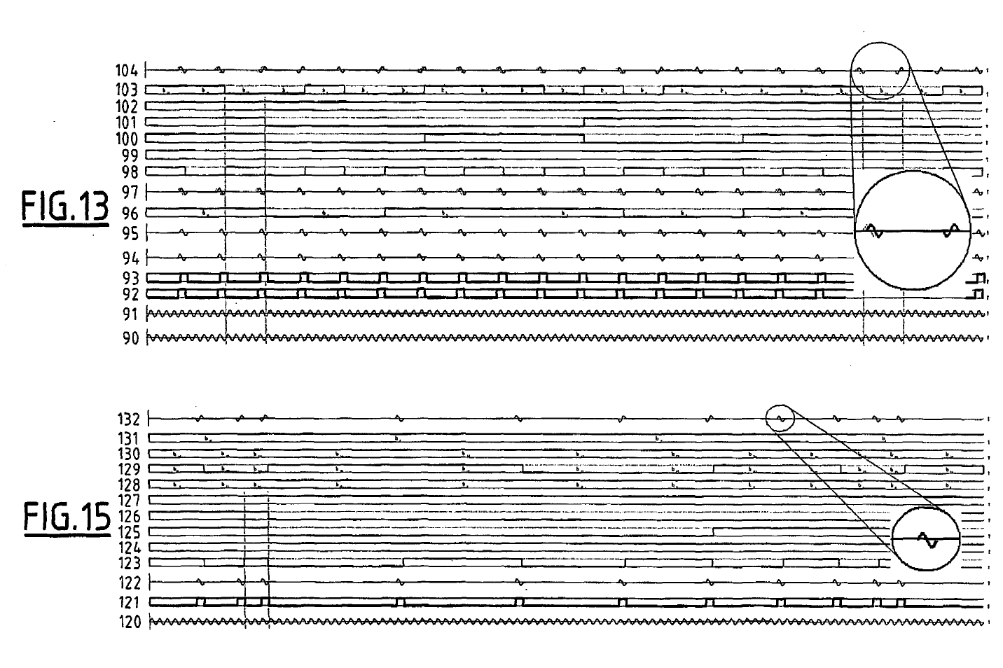

FIG. 13 is a chronogram corresponding to the BPSK-PPM modulation scheme. In this chronogram the 6 bits of command of the counter 6 are set to 000010. In these conditions, after 4 clock cycles, the counter generates the pulse signal g(t). In this chronogram,
curves 90 and 91 are, respectively, the I and Q clock signals in quadrature,
curves 92 and 93 are the I and Q gate signals respectively provided by the counter by N and the delay block,
curves 94 and 95 are respectively the product result of curves 90-92 and curves 91-93.
the curve 96 is the transmitted data. These data choose between the monocycles I or Q (curves 94 and 95),
the curve 97 is the result of the choice between curves 94 and 95 by the data 96. It corresponds to PPM modulated pulses with the data,
the curves 98, 99, 100 and 101 are the output bits of the counter 11 by 16. a0 divides by 2, a1 divides by 4, a2 divides by 8, a3 divides by 16. These division ratios control the multiplexer 12 to serialize the PN sequence code,
the curve 102 is the loading signal used to enable the multiplexer 12 for the next loading of the PN sequence code,
the curve 103 is the multiplexer output signal (serialized PN sequence code), and
the curve 104 is the desired modulation (see zoom area). Between the code 0 and 1 the relative position of the pulse has changed (PPM modulation) and the phase has moved by 180° (BPSK modulation).

FIG. 14 is a block diagram of the monocycle generator with PPM-BPSK modulation (PPM for the code and BPSK for the data). This configuration is also an association between the previous configuration BPSK-BPSK and PPM-PPM. Data to transmit are inputted into the multiplier 22.

FIG. 15 is a chronogram corresponding to the PPM-BPSK modulation scheme, where:
the curve 120 is the clock signal,
the curve 121 is the output signal of the counter by N for a minimum division ratio of 3 and a maximum division ratio of 17. So the code is 00XXX1,
the curve 122 is the product result between curves 120-121 at the multiplier 7 output. These monocycles are modulated in position (PPM modulation),
the curves 123, 124, 125 and 126 are the output bits of the counter by 16. a0 divides by 2, a1 divides by 4, a2 divides by 8, a3 divides by 16. These division ratios control the multiplexers 12A, 12B and 12C to serialize the PN sequence code,
the curve 127 is the loading signal used to enable the multiplexers for the next loading of the PN sequence code,
the curves 128, 129 and 130 are the three multiplexers output signals (serialized PN sequence code),
the curve 131 is the data to transmit, and
the curve 132 is the desired modulation (see zoom area).

An integrated circuit has been designed, simulated and produced according to the here above embodiment of the pulse generator.

The technology used is a BICMOS SIGe technology featuring a transition F_{T} frequency of 75 GHz and a maximum frequency F_{MAX} of 90 GHz.

An external single ended sinusoidal waveform source is used to generate the input clock signal x(t) of the sinusoidal monocycle generator.

Measurements are made with an input frequency of 6 GHz and 5.5 GHz and a supply voltage of 2.7 V.

With these conditions, the circuit has a power consumption of 90 mA.

For a bi-phase modulation, the output impulses feature a width of 165 ps with a 300 mV peak. The pseudo-noise sequence code modulates the pulses phase by 0 or 180°.

1. A pulse generator comprising a sinusoidal monocycle generator (4) said sinusoidal monocycle generator (4) comprising a sinusoidal wave source (5) connected to a first switch (6) and to a first input of a first multiplier (7), the output of said switch being a square pulse synchronized with a sinusoidal wave generated by the sinusoidal wave source and having a pulse width equal to one period of said sinusoidal wave in the time domain, said switch (6) output being connected to a second input of said first multiplier (7) so that the output of said multiplier is a sinusoidal monocycle.

2. A pulse generator according to claim 1, characterized in that the switch is a synchronous counter having a clock input and control inputs, the sinusoidal wave being the clock of said counter and the control inputs defining the number of periods of the clock separating each square pulse outputted from said counter.

3. A pulse generator according to claim 1, characterized in that it further comprises a pseudo-noise sequence prescaler (10), said pseudo-noise sequence prescaler being synchronized with the output of said switch (6).

4. A pulse generator according to claim 3, characterized in that said pseudo-noise sequence prescaler (10) comprises a counter (11) synchronized with the output of said switch (6), said counter driving at least a multiplexer (12) to serialize a subset of a pseudo-noise sequence code (13).

5. A pulse generator according to claim 4, characterized in that serialized data (20) and serialized pseudo-noise sequence code (14) are inputs of a second multiplier (21), the output of said second multiplier and the output of said sinusoidal monocycle generator (4) being inputs of a third multiplier (22) so that the output of said third multiplier (22) is a bi-phased shift keying (BPSK) modulated signal.

6. A pulse generator according to claim 4, characterized in that said sinusoidal monocycle generator comprises
at least one first delay (50) connected to the output of the sinusoidal waveform generator such that at least one sinusoidal waveform with a phase shift is generated,
at least one second delay (51) having an input connected to the output of said first switch (6) and a control input connected to one of said first delay (50), so that each second delay (51) outputs a square pulse synchronized with the phase-shifted sinusoidal waveform and having a pulse width equal to one period of said sinusoidal wave in the time domain, and
two switches (52, 53) having respectively a number of data inputs equal to the number of sinusoidal waveforms, control inputs receiving data to be transmitted, and one output connected to the input of said first multiplier (7) such that, depending of the value of the data to be transmitted, a specific phase shifted sinusoidal wave form and its corresponding square pulse are transmitted to said first multiplier (7) so that a pulse position modulated (PPM) signal is generated.

7. A pulse generator according to claim 4, characterized in that said pseudo-noise sequence prescaler (10) comprises at least two multiplexers (12A, 12B, 12C) having their respective outputs connected to control inputs of said first switch (6) of said sinusoidal monocycle generator (4) such that the number of periods of the sinusoidal waveform separating each square pulse is varying function of the values of the serialized subset of the pseudo-noise sequence code (14A, 14B, 14C).

8. A pulse generator according to claim 6, wherein said pseudo-noise sequence prescaler (10) comprises at least two multiplexers (12A, 12B, 12C) having their respective outputs connected to control inputs of said first switch (6) of said sinusoidal monocycle generator (4) such that the number of periods of the sinusoidal waveform separating each square pulse is varying function of the values of the serialized subset of the pseudo-noise sequence code (14A, 14B, 14C);
characterized in that the output of said pulse generator is a pulse position modulated signal for code and data.

9. A pulse generator according to claim 6, characterized in that the output of said multiplier (12) of said pseudo-noise sequence prescaler (10) and the output of said sinusoidal waveform monocycle are connected to inputs of a multiplier (22) such that said multiplier generates a modulated pulse signal in which the pseudo-noise sequence code is modulated according to a bi-phased shift keying modulation and the data is modulated according to a pulse position modulation.

10. A pulse generator according to claim 7, characterized in that the output of said sinusoidal monocycle generator (4) and serialized data to be transmitted are inputs of a multiplier such that said multiplier generates a modulated pulse signal in which the pseudo-noise sequence code is modulated according to a pulse position modulation and data is modulated according to a bi-phased shift keying modulation.

11. A pulse generator according to claim 2, characterized in that it further comprises a pseudo-noise sequence prescaler (10), said pseudo-noise sequence prescaler being synchronized with the output of said switch (6).
